(19) United States
(12) Patent Application Publication
(10) Pub. No.: US 2017/0140022 A1
(43) Pub. Date: May 18, 2017

(54) IDENTIFYING AN ASSUMPTION ABOUT A USER, AND DETERMINING A VERACITY OF THE ASSUMPTION

(71) Applicant: Google Inc., Mountain View, CA (US)

(72) Inventors: Jinan Lou, Cupertino, CA (US); Hongtao Zhong, Belmont, CA (US)

(73) Assignee: Google Inc., Mountain View, CA (US)

(21) Appl. No.: 14/289,355

(22) Filed: May 28, 2014

(51) Int. Cl. G06F 17/30; G06N 99/00

(52) U.S. Cl. CPC G06F 17/30595; G06F 17/30876; G06N 99/005

(57) ABSTRACT

Methods, apparatus and computer-readable media (transitory and non-transitory) are disclosed for analyzing a document associated with a user to identify an assumption about the user, comparing the assumption with on one or more signals that are associated with the user and separate from the document to determine a veracity of the assumption, and updating one or more techniques for identifying an assumption based on feedback that is generated based on the veracity.

### BACKGROUND

Automatic extraction of various user-related information from user-related electronic documents may help a user to be organized. For example, when a user receives an email from an airline with an itinerary, it may be helpful to the user if that itinerary is automatically extracted and corresponding entries are added to the user's calendar. When a format of such an email is known—which may be the case when an airline generates such emails automatically and on a large scale —the same technique may be used to extract the itinerary every time. However, formats of such emails may change over time and/or between airlines. Additionally, the user may receive “informal” emails, e.g., dictated by human beings rather than automatically, with less predictable formats that make extraction of useful information more difficult. Determining how to better and more precisely extract user-related information from user-related documents may be difficult when, for reasons such as those relating to privacy and security, users wish to limit access to such user-related documents.

### SUMMARY

This specification is directed generally to methods and apparatus for analyzing a document associated with a user, such as a communication to or from the user, to identify one or more assumptions about the user, and determining a veracity of the assumption based on one or more other signals. In some implementations, a user communication such as an email or text message may be analyzed to identify an assumption related to an event in which the user has participated, is participating, or will participate. The assumption about the event may include various attributes of the event, such as an event location and an event time. Those assumed event attributes may be compared to one or more signals (e.g., associated with or independent of the user) to determine a veracity of the assumption. Signals to which the assumption and/or assumption attributes may be compared may include but are not limited to position coordinates provided by a mobile computing device operated by the user, a calendar entry associated with the user, another communication to or from the user, a search history of the user, a purchase history of the user, a browsing history of the user, online schedules and calendars related to the user or to travel carriers (e.g., airlines, train carriers, bus lines) and so forth.

Suppose that an assumption is made based on text contained in an email received by a user from a travel agent that the user will depart San Francisco Airport at 10 am on a specified date. A veracity of that assumption may be determined based in part on at least one or more signals—e.g., a position coordinate and a corresponding timestamp —obtained from the user's mobile phone. If the position coordinate indicates that the user was at the San Francisco Airport, but the timestamp is off, or vice versa, then the assumption may have less veracity than if both the position coordinate and timestamp corroborate the assumption. In either case, the veracity, aspects of the assumption, and/or content of the communication may be used to improve the process (e.g., machine learning, rules-based parsing, etc.) by which assumptions are identified from user documents.

In some implementations, a computer implemented method may be provided that includes the steps of: analyzing, by a computing system using a machine learning classifier, a communication sent or received by a user to identify an assumption about the user; comparing, by the computing system, the assumption with on one or more signals that are associated with the user and separate from the communication to determine a veracity of the assumption; and training, by the computing system, the classifier based on feedback that is generated based on the veracity.

In some implementations, a computer implemented method may be provided that includes the steps of: analyzing, based on a plurality of rules, a document associated with a user; identifying, based on content of the document and at least one of the plurality of rules that is applicable to the content, an assumption about activity of the user; determining, based on one or more signals that are associated with the user and separate from the document, a veracity of the assumption; and providing information indicative of the veracity and the applicable rule.

In some implementations, a computer-implemented method may be provided that includes the steps of: identifying a document associated with a user; determining an assumption about an activity of the user based on content of the document; selecting one or more signals associated with the user and separate from the document based on the assumption; determining a veracity of the assumption based on a comparison of the assumption to the selected one or more signals; and providing information indicative of the veracity.

These methods and other implementations of technology disclosed herein may each optionally include one or more of the following features.

In various implementations, one or more signals associated with the user may include a position coordinate obtained from a mobile computing device associated with the user. In various implementations, the assumption comprises an event with an event location, and determining the veracity comprises comparing the event location with the position coordinate. In various implementations, the event includes an event time, and determining the veracity further comprises comparing the event time with a timestamp associated with the position coordinate.

In various implementations, one or more signals associated with the user may include a calendar entry associated with the user, a purchase history associated with the user, a browsing history associated with the user, or search engine query history the user. In various implementations, the communication is a first communication, and the one or more signals associated with the user include information contained in a second communication, distinct from the first communication, that is sent or received by the user.

In various implementations, determining the veracity comprises determining the veracity based at least in part on a confidence level associated with the one or more signals. In various implementations, determining the veracity comprises determining the veracity based at least in part on a count of the one or more signals that corroborate the assumption. In various implementations, the method further includes selecting the one or more signals based on the assumption.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which user documents may be analyzed to identify one or more assumptions about users and determine veracities of those assumptions.

FIG. 2 illustrates one example of how a user document may be analyzed to identify one or more assumptions about a user, as well as how a veracity of that assumption may be determined.

FIG. 3 is a flow chart illustrating an example method of analyzing user documents to identify one or more assumptions about users and determining veracities of those assumptions.

FIG. 4 illustrates an example architecture of a computer system.

### DETAILED DESCRIPTION

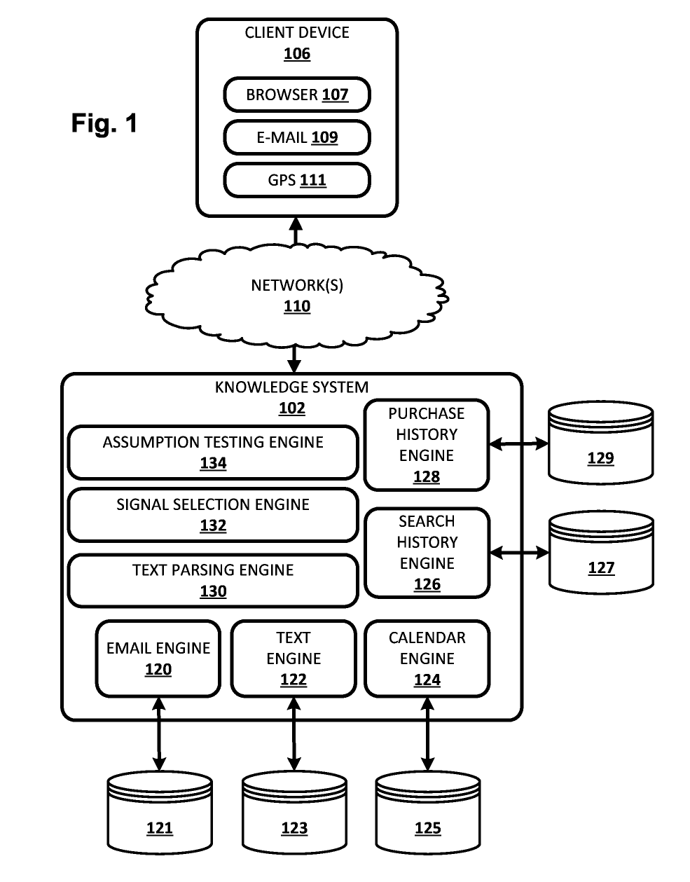

FIG. 1 illustrates an example environment in which user documents may be analyzed to identify one or more assumptions about users, and in which veracities of those assumptions may be determined. The example environment includes a client device 106 and a knowledge system 102. Knowledge system 102 may be implemented in one or more computers that communicate, for example, through a network (not depicted). Knowledge system 102 is an example of an information retrieval system in which the systems, components, and techniques described herein may be implemented and/or with which systems, components, and techniques described herein may interface.

A user may interact with knowledge system 102 via client device 106 and/or other computing systems (not shown). Client device 106 may be a computer coupled to the knowledge system 102 through one or more networks 110 such as a local area network (LAN) or wide area network (WAN) such as the Internet. The client device 106 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device). Additional and/or alternative client devices may be provided. While the user likely will operate a plurality of computing devices, for the sake of brevity, examples described in this disclosure will focus on the user operating client device 106. Client device 106 may operate one or more applications and/or components which may facilitate user consumption and manipulation of user documents, as well as provide various types of signals. These application and/or components may include but are not limited to a browser 107, email client 109, position coordinate component, such as a global positioning system (“GPS”) component 111, and so forth. In some instances, one or more of these applications and/or components may be operated on multiple client devices operated by the user. Other components of client device 106 not depicted in FIG. 1 that may provide signals include but are not limited to barometers, Geiger counters, cameras, light sensors, presence sensors, thermometers, health sensors (e.g., heart rate monitor, glucose meter, blood pressure reader), accelerometers, gyroscopes, and so forth.

As used herein, a “user document” or “document” may include various types of documents associated with one or more users. Some documents may be user communications, such as emails, text messages, letters, and so forth. Other documents may include but are not limited to email drafts, diary entries, personal or business web pages, social networking posts, user spreadsheets (e.g., that the user uses to organize a schedule), audio and/or visual documents (e.g., voicemail with assumptions identified based on speech recognition), meeting minutes, statements (e.g., financial), conversation transcripts, memoranda, task lists, calendar entries, and so forth.

Client device 106 and knowledge system 102 each include one or more memories for storage of data and software applications, one or more processors for accessing data and executing applications, and other components that facilitate communication over a network. The operations performed by client device 106 and/or knowledge system 102 may be distributed across multiple computer systems. Knowledge system 102 may be implemented as, for example, computer programs running on one or more computers in one or more locations that are coupled to each other through a network.

In various implementations, knowledge system 102 may include an email engine 120, a text messaging engine 122, a calendar engine 124, a search history engine 126, a purchase history engine 128, a text parsing engine 130, a signal selection engine 132, and/or an assumption testing engine 134. In some implementations one or more of engines 120, 122, 124, 126, 128, 130, 132, and/or 134 may be omitted. In some implementations all or aspects of one or more of engines 120, 122, 124, 126, 128, 130, 132, and/or 134 may be combined. In some implementations, one or more of engines 120, 122, 124, 126, 128, 130, 132, and/or 134 may be implemented in a component that is separate from knowledge system 102. In some implementations, one or more of engines 120, 122, 124, 126, 128, 130, 132, and/or 134, or any operative portion thereof, may be implemented in a component that is executed by client device 106.

Email engine 120 may maintain an index 121 of email correspondence between various users that may be available, in whole or in selective part, to various components of knowledge system 102. For instance, email engine 120 may include an email server, such as a simple mail transfer protocol (“SMTP”) server that operates to permit users to exchange email messages. In various implementations, email engine 120 may maintain, e.g., in index 121, one or more user mailboxes in which email correspondence is stored. Similar to email engine 120, text messaging engine 122 may maintain another index 123 that includes or facilitates access to one or more text messages exchanged between two or more users. While depicted as part of knowledge system 102 in FIG. 1, in various implementations, all or part of email engine 120, index 121 (e.g., one or more user mailboxes), text messaging engine 122 and/or index 123 may be implemented elsewhere, e.g., on client device 106.

Calendar engine 124 may be configured to maintain an index 125 of calendar entries and other scheduling-related information pertaining to one or more users. Search history engine 126 may maintain an index 127 of one or more search histories associated with one or more users. Purchase history engine 128 may maintain an index 129 of one or more purchase histories associated with one or more users. Index 129 may include evidence of purchase history in various forms, including but not limited to a list of purchases made with one or more credit cards or electronic wallets, a corpus of financial statements (e.g., bank statements, credit card statements), receipts, invoices, and so forth. While depicted as part of knowledge system 102 in FIG. 1, in various implementations, all or part of calendar engine 124, search history engine 126, and/or purchase history engine 128, and/or their respective indices 125, 127 and/or 129, may be implemented elsewhere, e.g., on client device 106.

In this specification, the term “database” and “index” will be used broadly to refer to any collection of data. The data of the database and/or the index does not need to be structured in any particular way and it can be stored on storage devices in one or more geographic locations. Thus, for example, the indices 121, 123, 125, 127 and/or 129 may include multiple collections of data, each of which may be organized and accessed differently.

In some implementations, text parsing engine 130 may obtain one or more user documents, e.g., from one or more of email engine 120, text messaging engine 122, calendar engine 124, or elsewhere, and may analyze the document to identify one or more assumptions about a user. In various implementations, text parsing engine 130 may utilize various techniques, such as regular expressions, machine learning, rules-based approaches, heuristics, co-reference resolution, object completion, and so forth, to identify one or more assumptions about a user in a document.

Suppose a user receives an email from a friend with the text, “Hi Bill, Jane is going to arrive at my house at 4:30 tomorrow afternoon. Can you arrive one half hour later?-Dan” Text parsing engine 130 may resolve “tomorrow” as the day following the day the email was sent, which may be determined, for instance, based on metadata associated with the email. Text parsing engine 130 may also co-reference resolve “you” with “Bill,” since the email is addressed to “Bill.” Text parsing engine may assemble a scheduled arrival time for Bill—5:00 pm —from a combination of Jane's arrival time (4:30), the word “afternoon” (which may lead text parsing engine 130 to infer “pm” over “am”), and the phrase “one half hour later.” Text parsing engine 130 may also infer a location—Dan's house—and may infer that Bill is requested to be there, from the word “arrive.” Depending on information available to text parsing engine 130—e.g., if it has access to an electronic contact list of Bill and/or Dan —text parsing engine 130 may further determine Dan's address. Text parsing engine 130 may put all this together to identify assumptions that the user “Bill” is supposed to be at Dan's house at 5:00 pm the day after the date the email was sent.

Signal selection engine 132 may be configured to select, from a plurality of signals that may be available to assumption testing engine 134, one or more signals that are comparable to one or more assumptions identified by text parsing engine 130. In some implementations, signal selection engine 132 may select one or more signals based on a particular rule utilized by text parsing engine 130 to identify one or more assumptions. For example, if an applicable rule is designed to identify flight arrival times, signal selection engine 132 may identify signals that may tend to corroborate identified flight times, such as airline flight schedules, purchase history engine 128 (which may show that a user purchased a ticket on the identified flight), a position coordinate obtained when the user turns her smart phone on after landing, and so forth. In some implementations, signal selection engine 132 may utilize attributes of assumptions to select one or more corroborating signals. For example, if an assumption includes an event occurring at a particular location and associated date/time, signal selection engine 132 may select signals that may corroborate or refute (i) the event, (ii) the location, and (iii) the time.

Assumption testing engine 134 may be configured to compare one or more assumptions, e.g., identified by text parsing engine 130 with one or more signals, e.g., selected by signal selection engine 132. Based on such comparisons, assumption testing engine 134 may determine veracities of those one or more assumptions. A “veracity” of an assumption may be expressed in various ways. In some implementations, an assumption's veracity may be expressed as a numeric or alphabetical value along a range, e.g., from zero to one or from “A+” to “F−.” In some implementations, an assumption's veracity may be expressed in more absolute fashion, e.g., as positive (e.g., “true”) or negative (e.g., “false”). Assumptions that are more positively corroborated may receive higher veracity values, whereas assumptions that are wholly or partially contradicted or otherwise negated may receive lower veracity values. Assumption testing engine 134 may perform various actions once it has determined a veracity of an assumption.

In implementations where text parsing engine 130 utilizes machine learning, assumption testing engine 134 may provide, e.g., as training data to a machine learning classifier utilized by text parsing engine 130, feedback that is generated at least in part based on the veracity. In some implementations, assumption testing engine 134 may generate feedback that includes an indication of the veracity itself, e.g., expressed as a value in a range. Assumption testing engine 134 may include other information in the feedback as well, including but not limited to content (e.g., patterns of text) in the document that lead to the assumption being identified, annotations of the assumptions made, and so forth.

In implementations where text parsing engine 130 utilizes rules-based techniques, assumption testing engine 134 may provide to text parsing engine 130 feedback that is generated at least in part based on the veracity and indicative of at least one applicable rule that was applied by text parsing engine 130 to identify the assumption. Text parsing engine 130 may then update, create, and/or modify one or more rules to adapt to the indicated veracity.

Assumption testing engine 134 may compare a variety of signals to assumptions to determine veracities of those assumptions. These signals may be obtained from various sources, such as client device 106 or knowledge system 102. These signals may include but are not limited to email engine 120, text messaging engine 122, calendar engine 124, search history engine 126, purchase history engine 128, a user's browser 107, email client 109, a position coordinate signal (e.g., from GPS component 111), one or more social network updates, various components on client device 106 (some which are mentioned above), and so forth.

Suppose an email from Bob to Tom includes the sentence, “I leave from SFO at 10 am on May 10. I land at JFK at 6.” Two assumptions may be identified, e.g., by text parsing engine 130, from this text: Bob departs San Francisco airport at 10 am PST on May 10; and Bob arrives at John F Kennedy Airport at 6 pm EST, also on May 10. Various signals associated with Bob (or Tom) may then be utilized to determine a veracity of these assumptions. For instance, Bob's phone may provide a GPS signal and time stamp that together indicate that Bob was at the San Francisco airport at or around 10 am PST on May 10. This signal may corroborate the first assumption, i.e., that Bob departs SFO at 10 am PST on May 10. A similar GPS/timestamp signal from JFK later that night may corroborate the second assumption. It should be noted that position coordinates may be obtained using means other than GPS, including but not limited to triangulation (e.g., based on cell tower signals), and so forth.

Other signals may be used by assumption testing engine 134 to determine assumption veracities. For instance, in implementations where an assumption is identified by text parsing engine 130 in a user textual communication (e.g., email, text, etc.), another textual communication associated with that user may be used as a signal. Suppose Bob received another email from an airline with an itinerary that corroborates (or refutes) Bob's proposed flight plan discussed above. Such an email may serve as a relatively strong signal that the initial assumptions were correct, even if Bob ultimately does not board his flight.

As another example, Bob's purchase history (e.g., from purchase history engine 128) may include purchase of a plane ticket, or even a purchase of food in one or both of the departure and arrival airports, that corroborates (or refutes) Bob's flight plan. As yet another example, a calendar entry obtained from calendar engine 124 may corroborate (or refute) one or more of the assumptions made based on Bob's email to Tom. For instance, suppose Bob has a calendar entry that indicates Bob will be in Chicago on May 10^{th}. That may tend to contradict Bob's email. However, if the calendar entry was created subsequently to Bob's email to Tom, that may instead suggest that Bob cancelled his flight or otherwise changed his plans. In such case, the initial assumptions about Bob's travel plans may have been correct.

As yet another example, one or more aspects images obtained by mobile device 106 may be used as signals to corroborate or refute an assumption. For instance, suppose an assumption is made that a user will be at a particular landmark at a particular date/time. Suppose also that a digital photograph is obtained, e.g., from the user's phone or from the phone of another user, that has the user “tagged” (e.g., identified in metadata associated with the digital photo), and that photograph was taken at or near the assumed time. Geographic-identifying information associated with the digital photograph, such as a geo-location metadata sufficiently close to that of the landmark or even an indication that the landmark was “tagged” in the photograph, may be used to corroborate the user's presence at the landmark. For instance, if the assumed landmark is the Eifel Tower, but a photograph is obtained that shows the user tagged at the Sydney Opera House at the assumed time, then the veracity of the assumption that the user would be at the Eifel tower is clearly low.

Some signals may be more probative of the veracity of an assumption than others. For example, if an assumption is made that a user will be at a particular location at a particular time, a signal from GPS component 111 with an associated timestamp that corroborates that assumption (e.g., confirms that the user was in fact at the assumed location at the assumed time) may be particularly strong, perhaps even dispositive. By contrast, a signal from search history engine 126 about the user's search history may be relatively weak. For example, the user may have searched about the assumed location two days prior to the user's assumed arrival at the assumed location. Without more, that search history may only be somewhat probative —and likely not dispositive —that the user in fact was at the assumed location at the assumed time. As another example, a position coordinate obtained via GPS component 111 may have a higher confidence than say, a position coordinate obtained using other techniques, such as triangulation. According, in various implementations, signals may have associated “strengths” or “confidences.”

In various implementations, confidences of various signals may be weighed, e.g., by assumption testing engine 130, alone or collectively, to determine veracities of one or more assumptions. For example, two or more signals with high confidences that all corroborate an assumption may yield a very high, or even dispositive, veracity. On the other hand, a strong signal that corroborates an assumption combined with a strong signal that refutes the assumption may result in a neutral veracity. Many signals may have higher confidences when combined with other signals than they would have alone. For example, a position coordinate by itself may be of limited value when attempting to confirm whether an assumption about an event is accurate. Suppose an assumption is made based on a user's email that the user will be at a particular restaurant at dinnertime on a particular Saturday. If that restaurant happens to be on the user's way home from work, client device 106 may return a GPS signal every day after work indicating that the user was at the location. But if those daily GPS signals do not include a corroborative timestamp, those GPS signals may be nothing more than noise that should be ignored when determining the veracity of the assumption.

In various implementations, the one or more signals used to determine veracity may be separate from and/or distinct from the document from which the assumption was identified. For example, if one or more assumptions are identified from an email between users, then those assumptions may be compared to signals separate from that email, such as calendar entries, GPS signals, other user correspondence, and so forth, to determine veracities. In some implementations, separate emails, which still forming part of a single email thread or “conversation,” may nonetheless be considered separate and therefore used as signals for each other. For instance, suppose a user A receives an email invite to an event hosted by user B. User A may forward the email invite to user C, who may respond, “Let's meet at subway station ‘XYZ’ one half hour prior to the event and ride over together. Assumption testing engine 134 may use C's response, in combination with other signals such as applicable subway schedules, to corroborate an assumption drawn from the email invite from B to A.

In various implementations, assumptions and/or signals may be “daisy chained” across users to facilitate corroboration. For instance, suppose once again that a user A receives an email invite to an event hosted by user B. An assumption may be identified, e.g., by text parsing engine 130, that A will be at B's event. User A may send the invite to user C so that C may join A at B's event. In some instance, a second assumption may be identified, e.g., by text parsing engine 130, that C will also be at B's event, and that A will accompany C. A GPS signal and timestamp from C's mobile phone may then be used to corroborate A's presence at B's event, e.g., if A doesn't have a mobile phone. Additionally or alternatively, a photograph taken by B's mobile phone that identifies (e.g., “tags”) A and also includes a geo location and/or timestamp may corroborate A's presence at B's event, and thus may increase a veracity of the assumption extracted from the email invite from B to A.

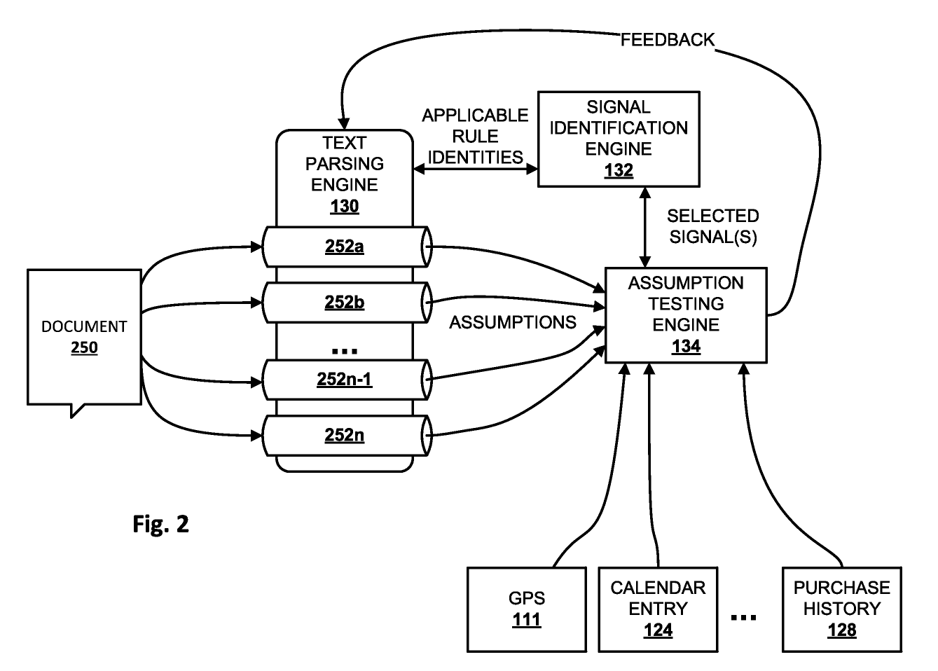

FIG. 2 schematically depicts one example of how a document 250 associated with a user may be analyzed by various components configured with selected aspects of the present disclosure to identify one or more assumptions about a user, as well as how veracities of those one or more assumptions may be determined. As noted above, document 250 may come in various forms, such as an email sent or received by the user, a text message sent or received by the user, and so forth. In various implementations, document 250 may first be processed by text parsing engine 130. While not shown in FIG. 2, in some embodiments, one or more annotators may be employed, e.g., upstream of text parsing engine 130, e.g., to identify and annotate various types of grammatical information in document 250. In such embodiments, text parsing engine 130 may utilize these annotations to facilitate identification of one or more user assumptions.

In the embodiment of FIG. 2, text parsing engine 130 may employ a plurality of rules 252a-n to identify one or more assumptions about a user from document 250. Each rule 252 may be configured to identify a particular type of assumption about a user (e.g., departure time, arrival time, etc.). A user assumption may be identified by text parsing engine 130 based on content of document 250, e.g., using known text patterns, regular expressions, co-reference resolution, object identification, and so forth. For example, text parsing engine may include a rule 252 that utilizes a regular expression such as the following:
[Dd](EPART|epart)[A-z]{0,3}\s*([Tt][Ii][m][Ee])?[:-]?\s*(1?[0-9]|2[0-3])?:?[0-5]?[0-9]?\s*([Aa]|[Pp])?[Mm]?

Such a rule would extract assumed departure times from various textual patterns, such as “Departing:10:54 am,” “Depart 2300,” “DEPARTURE:11 pm,” and so forth. A user assumption may also be identified by text parsing engine 130 based on other data associated with document 250, including but not limited to metadata (e.g., author, date modified, etc.), sender, receiver, date sent, date received, document type (e.g., email, text, etc.), and so forth.

While a rules-based text parsing engine 130 is depicted in FIG. 2, this is not meant to be limiting. In various implementations, text parsing engine 130 may employ machine learning, e.g., based on a machine learning classifier, to identify assumptions from user documents. In such embodiments, the machine learning classifier may be trained using feedback that is generated at least in part based on a determined veracity of an assumption. A relatively high level of veracity may translate as positive training data for the classifier. A relatively low level of veracity may translate as negative training data for the classifier.

Returning to FIG. 2, in various implementations, text parsing engine 130 may output one or more assumptions identified from document 250. These assumptions may be compared, e.g., by assumption testing engine 134, with one or more signals (non-limiting examples depicted at bottom right) to determine veracities of those assumptions. As shown in FIG. 2, signal selection engine 132 may communicate with text parsing engine 130 to identify one or more rules 252 that were successfully applied to identify an assumption from document 250. Signal selection engine 132 may then identify one or more user signals that may be used by assumption testing engine 134 to determine a veracity of the applied rules.

In various implementations, assumption testing engine 134 may consult with signal selection engine 132 to identify one or more signals with which to compare one or more assumptions output by text parsing engine 130. In other implementations where signal selection engine 132 is not present, assumption testing engine 134 may determine which signals to test assumptions with using other means, such as one or more attributes of an assumption. For example, an assumption that a user will be departing a particular airport on a particular flight may have various attributes, such as a departure date/time, a departure airport, a flight number, an airline identifier, and so forth. Assumption testing engine 134 may compare an assumed combination of date/time and departure airport with a signal obtained from GPS component 111 of the user's smart phone at the assumed date/time. If the GPS signal indicates that the user is at the assumed departure airport, the assumption was likely correct, and assumption testing engine 134 may provide text parsing engine 130 with positive feedback (or no feedback in some instances).

If the user was not at the departure airport at the assumed date/time, either the assumption was incorrect, in which case assumption testing engine 134 may provide negative feedback (or no feedback in some instances), or the assumption was correct but the user changed plans. In the latter case, assumption testing engine 134 may look to other sources of information to confirm that the user changed plans. These other sources of information may include one or more other assumptions that tend to contradict the uncorroborated assumption, as well as other signals (e.g., calendar entries 124, other emails, purchase history 128, etc.) that corroborate that the user simply changed plans. If assumption testing engine 134 confirms that the user changed plans, assumption testing engine 134 may refrain from providing negative feedback to text parsing engine 130. In some implementations, assumption testing engine 134 may even provide positive feedback to text parsing engine 130 if assumption testing engine 134 is sufficiently confident that the user originally did intend to depart the assumed airport at the assumed time/date, but changed plans later.

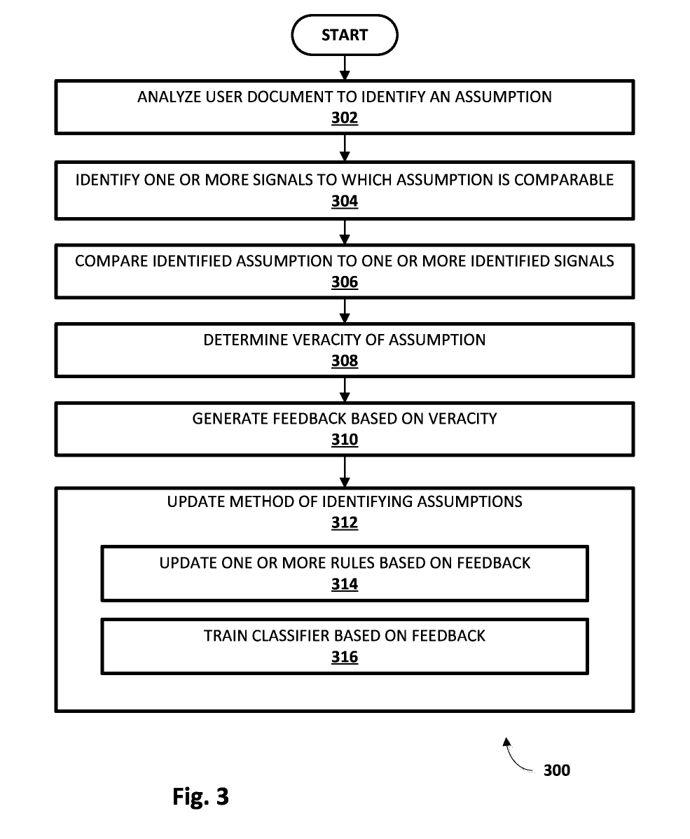

FIG. 3 schematically depicts an example method 300 of identifying assumptions from user documents and determining veracities of those assumptions. For convenience, the operations of the flow chart are described with reference to a system that performs the operations. This system may include various components of various computer systems. For instance, some operations may be performed at the client device 106, while other operations may be performed by one or more components of the knowledge system 102, such as email engine 120, text messaging engine 122, calendar engine 124, search history engine 126, purchase history engine 128, text parsing engine 130, signal selection engine 132, assumption testing engine 134, and so forth. Moreover, while operations of method 300 are shown in a particular order, this is not meant to be limiting. One or more operations may be reordered, omitted or added.

At block 302, the system may analyze a user document, such as a communication sent or received by the user (e.g., an email), to identify an assumption (or multiple assumptions) about the user. At block 304, the system may identify, e.g., by way of signal selection engine 132, one or more signals to which the assumption is comparable. For example, suppose the assumption is that a user will be at a location at a particular date/time. One signal that may be identified as potentially corroborative is a position coordinate obtained at or near the date/time. Another signal that may be identified as potentially corroborative is calendar entry associated with the user that has an associated location, date and/or time that corresponds to the one or more of the assumed location, date and/or time. Another signal that may be identified as potentially corroborative is an indication from the user's purchase history that the user purchased something (e.g., a train ticket) that has an associated location, date and/or time that corresponds to the one or more of the assumed location, date and/or time.

Another signal that may be identified as potentially corroborative is another communication sent or received by the user (e.g., an airline or hotel confirmation email, text message to a spouse, etc.) that corroborates one or more of the assumed location, date and/or time. Another signal that may the system may identify as potentially corroborative is one or more past search engine queries from the user. For instance, the user past searches for “good food at or near [the assumed location]” may tend to corroborate the user's presence at the assumed location at the assumed date/time (though as noted above, a confidence associated with a user's search may be lower than a confidence associated with, say, a GPS signal that indicates the user was at the assumed location at the assumed date/time).

At block 306, the system may compare the assumption identified at block 302 to the one or more signals identified at block 304. At block 308, the system may determine a veracity of the assumption based on the comparison performed at block 306. In some implementations, determining the veracity may include determining the veracity based at least in part on a confidence level associated with the one or more signals. For example, a calendar entry with a location and time may be a stronger signal to corroborate a user's presence at an event than say, an email to the user confirming a reservation at a hotel near the assumed event location.

In some implementations, determining the veracity may include determining the veracity based at least in part on a count of the one or more signals that corroborate the assumption. For example, the veracity of a first assumption corroborated by a single signal (count=1) may be lower than the veracity of a second assumption corroborated by multiple signals. On the other hand, in some implementations, both a count of signals and a confidence associated with each of those signals may be taken into account. In such case, an assumption corroborated by two relatively strong signals may have a higher veracity than an assumption corroborated by, for instance, four relatively weak signals.

Returning to FIG. 3, at block 310, the system may generate feedback based at least in part on the veracity determined at block 308. In some implementations, the feedback may include a direct indication of the veracity itself, e.g., as a numeric value. In other implementations, the feedback may only include an indirect indication of the veracity. For instance, if the veracity determined at block 308 satisfies some sort of threshold, the feedback may include an indication of the assumption itself. In some implementations, if the veracity of the assumption fails to satisfy a threshold, the feedback may include some indication that the assumption was invalid, or the feedback may even be omitted. The system (e.g., the text parsing engine 130 or assumption testing engine 134) may infer from the lack of feedback that the assumption has a low veracity. Of course, these are simply implementation-specific details; in other implementations, a lack of feedback could mean an assumption has high veracity.

At block 312, the system may update a method of identifying assumptions based at least in part on the feedback generated at block 310. In some implementations, a rules-based text parsing engine 130 may update one or more rules (e.g., 252a-n in FIG. 2) based on the feedback at block 314. In some implementations, a machine learning-based text parsing engine 130 may train a classifier at block 316 based on the feedback.

Although not depicted in FIG. 3, in some embodiments, the system may output, e.g., on a computer screen, information indicative of the veracity determined at block 308 to a human reviewer, without providing any content of the document to the human reviewer. This may prevent the human reviewer from being able to ascertain private information about a user.

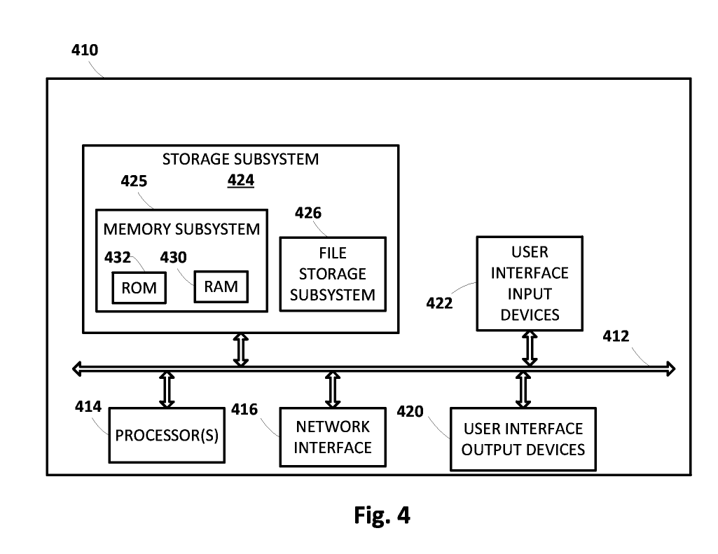

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, as well as one or more of the operations performed by email engine 120, text engine 122, calendar engine 124, search history engine 126, purchase history engine 128, text parsing engine 130, signal selection engine 132, assumption testing engine 134, and so forth.

These software modules are generally executed by processor 414 alone or in combination with other processors. Memory 425 used in the storage subsystem can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1-11. (canceled)

12. A system including memory and one or more processors operable to execute instructions stored in the memory, comprising instructions to:
analyze, based on a plurality of rules, a first document exchanged between a first person and a second person, wherein the first document pertains to an event;
identify, based on content of the first document and at least one of the plurality of rules that is applicable to the content of the first document, a plan of the second person to attend the event;
analyze, based on the plurality of rules, a second document exchanged between the second person and a third person, wherein the second document also pertains to the event;
identify, based on content of the second document and at least one of the plurality of rules that is applicable to the content of the second document, a plan of the third person to attend the event;
determine, based on a first signal of a plurality of signals that are associated with the third person, that the plan of the second person is corroborated; and
provide information indicative of corroboration of the plan of the second person.

13-15. (canceled)

16. The system of claim 12, wherein the system further comprises instructions to select the first signal based on the plan of the third user to attend the event.

17-25. (canceled)

26. A computer-implemented method comprising:
analyzing, based on a plurality of rules, a first electronic document exchanged between a first person and a second person, wherein the first document pertains to an event;
identifying, based on content of the first electronic document and at least one of the plurality of rules that is applicable to the content of the first electronic document, a plan of the second person to attend the event;
analyzing, based on the plurality of rules, a second electronic document exchanged between the second person and a third person, wherein the second electronic document also pertains to the event;
identifying, based on content of the second electronic document and at least one of the plurality of rules that is applicable to the content of the second electronic document, a plan of the third person to attend the event;
determining, based on a first signal of a plurality of signals that are associated with the third person, that the plan of the second person is corroborated; and
providing information indicative of corroboration of the plan of the second person.

27. The computer-implemented method of claim 26, further comprising selecting the first signal based on the plan of the third person to attend the event.

28. The computer-implemented method of claim 26, wherein the plurality of signals associated with the third person include a calendar entry associated with the third person or a purchase history associated with the third person.

29. The computer-implemented method of claim 26, wherein the first signal comprises a position coordinate provided by a mobile computing device associated with the third person.

30. The computer-implemented method of claim 26, wherein the plurality of signals associated with the third person include a calendar entry associated with the third person or a purchase history associated with the third person.

31. A non-transitory computer-readable medium comprising instructions that, in response to execution of the instructions by a computing system, cause the computing system to perform operations comprising:
analyzing, based on a plurality of rules, a first electronic document exchanged between a first person and a second person, wherein the first electronic document pertains to an event;
identifying, based on content of the first electronic document and at least one of the plurality of rules that is applicable to the content of the first electronic document, a plan of the second person to attend the event;
analyzing, based on the plurality of rules, a second electronic document exchanged between the second person and a third person, wherein the second electronic document also pertains to the event;
identifying, based on content of the second electronic document and at least one of the plurality of rules that is applicable to the content of the second electronic document, a plan of the third person to attend the event;
determining, based on a first signal of a plurality of signals that are associated with the third person, that the plan of the second person is corroborated; and
providing information indicative of corroboration of the plan of the second person.

32. The non-transitory computer-readable medium of claim 31, wherein the first signal comprises a position coordinate provided by a mobile computing device associated with the third person.

33. The non-transitory computer-readable medium of claim 31, wherein the plurality of signals associated with the third person include a calendar entry associated with the third person or a purchase history associated with the third person.
